(19) United States
(12) Patent Application Publication
(10) Pub. No.: US 2002/0055904 A1
(43) Pub. Date: May 9, 2002

(54) Apparatus and method for processing loans

(76) Inventor: Gary Le Mon, Salt Lake City, UT (US)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 09/899,728

(22) Filed: Jul. 3, 2001

Related U.S. Application Data
(63) Continuation-in-part of application No. 09/668,444, filed on Sep. 22, 2000.

(51) Int. Cl. G06F 17/60

(52) U.S. Cl. 705/38

(57) ABSTRACT

An apparatus and method for processing loans includes receiving a loan application from a remote location, including a payday loan machine, processing the loan and depositing funds to the debtor's account or dispensing the loans directly to the client.

### RELATED APPLICATIONS

The present application is a continuation-in-part of U.S. patent application Ser. No. 09/668555, filed Sep. 22, 2001.

### BACKGROUND OF THE INVENTION

1. Field of the Invention

The present invention relates to a method of handling financial transactions for those who need short term loans. More particularly, the present invention relates to an apparatus and process by which a person may apply for a short term loan and have the funds available at a remote location in a very short period of time.

2. State of the Art

There is large market demand for short term loans which can be used for any purposes desired by the borrower. One common method for obtaining such loans has been the placement of valuables with a pawn broker. The pawn broker advances money to the individual based on some portion of the valuables which has been placed as collateral. The debtor then has a certain period of time during which he or she must repay the loan, along with a handling fee and interest, or the valuables become the property of the pawn broker and are ultimately sold to recoup the money loaned.

While using a pawn broker may be convenient at times, the person needing the loan may not have valuables to pawn, or does not want to go through the processes of pawning goods which he or she wishes to later reclaim. Thus, many people needing short term loans prefer not to use a pawn broker.

Another more recent method for obtaining short term loans is commonly referred to as a “pay day loan.” In a “pay day loan”, the debtor contacts a lending agent and provides the lending agent with a post-dated check. The check is typically post-dated for the day after the debtor will receive his or her next pay check.

With some post dated check lenders, the debtor is given cash on the spot. While this is often extremely convenient for the debtor, it raises significant security issues. The lender must typically have bullet proof glass and other security measures to protect workers and a large amount of cash on hand. Additionally, the debtor must be careful because potential robbers know that a person leaving a post-dated check lender is likely to have several hundred dollars in cash.

Another method for giving the debtor relatively instant access to cash is to give the debtor a check that can be cashed at either the debtor's bank or the bank of the lender. The debtor is then able to use the money as he or she see fit, and the lender will make a relatively healthy return when the debtor's check is cashed several days later.

Post-dated check loans have become increasingly popular for a variety of reasons. For those caught in financial hard times, the “pay day loan” allows the individual to meet mandatory payments before they go delinquent and effectively, defer the expense associated with obtaining the short term loan. In other situations, the post-dated check loan may be advanced simply to allow the person to make a purchase of an item which is currently available at a price which justifies paying the premium for a short term loan. This includes some items which are sold on a cash only basis. Thus, the debtor is able to effectively obtain an advance on a coming pay check and ultimately save money by making the purchase during a necessary window.

Recently, a few companies have begun offering services over the Internet, with limited success, in which a person may apply for a loan by submitting information regarding his or her account, employment status, and other relevant information. The loan funds are then wired to the individual's account and are available the next day for use. Such a system has the advantage of not requiring the individual to go to the lending institution in order to obtain needed funds. This is highly desirable because many people do not wish to be seen going to a lending institution which offers post-dated checks as it may imply to others that the person is having financial difficulties.

In addition to avoiding the possibility of being seen at a post-dated check lender, using the Internet also allows the person to obtain loan funds without having to travel to the physical location of the post-dated check lender and at hours when the post-dated check lender is not open. In some communities, the nearest such lender may be a considerable distance away and may have inconvenient hours of operation.

One advantage which the conventional “pay day loan” or post-dated check lending location has, however, is that the individual is able to obtain their money virtually instantaneously. By having immediate access to the money, the person may be able to purchase the desired item of which only one is available, or may be able to otherwise access funds that are needed immediately. Another problem which is present with the Internet based methods of getting loans is that it requires the loan applicant to have access to the Internet from their given location. For many people who use “pay day loan” services, access to the Internet is difficult. Additionally, there are many instances in which a person may desire a “pay day loan” when the person is remote from their home or office and, therefore, would not be able to use the Internet to apply for the loan even though he or she may normally have access to the Internet.

Still another problem for many individuals is that they may not be in the vicinity of a bank at which they can access the funds in their account. This may be because the person is in a remote location, or may be in another state, where it is difficult to get merchants, etc., to honor checks drawn on the individuals checking account.

Thus, there is a need for a process for obtaining loans which enables the user to obtain a loan from a remote location. Additionally, there is a need for such a process which may enable the debtor to have virtually immediate access to the loan proceeds so that they may be used by the debtor.

### SUMMARY OF THE INVENTION

Thus, it is an object of the present invention to provide an improved apparatus and method.

The above and other aspects of the present invention are achieved in a method for processing a short term loan in which the debtor communicates with a remote lending institution. The lending institution obtains information from the debtor that is necessary to process a loan. The lending institution then deposits the loan proceeds into the debtor's bank account, or causes a check or cash to be given to the debtor at a remote location so that the debtor has almost immediate access to the needed funds.

In accordance with one aspect of the invention, the loan application is disposed at a remote location, other than a financial institution, which has a fax machine. The loan application is faxed to the lending institution with the appropriate documentation. The loan is then processed by the lending institution. Upon approval, the remote lending institution deposits funds into the debtor's account on the same day directly into the debtor's bank account where it may be immediately accessed.

In accordance with another aspect of the method of the present invention, cash or other sufficient funds are manually deposited directly into the debtor's bank account within thirty (30) minutes of submission of the loan application. The debtor is then able to use a remote teller machine or bank to access some portion of the loan funds immediately.

In accordance with another aspect of the present invention, the loan proceeds are deposited at a central processing location of the debtor's financial institution at which the deposit of funds is instantly credited to the debtor's account so that the funds become immediately available to the debtor.

In accordance with another aspect of the present invention, subsequent loans to the debtor may be made in response to a telephone request of a debtor so that funds are available within a predetermined period of time. The same method may also be used by the debtor to obtain extensions of time to pay the loan balance.

In accordance with yet another aspect of the present invention, the loan of a debtor may be processed from a single location which then instructs a “lender location” near the debtor's bank to deposit cash or certified funds into the debtor's account so that the funds are promptly available to the debtor regardless of his or her location.

In accordance with another aspect of the present invention, a “mobile lender location” is used to deposit funds in the account of clients of the lending institution. The mobile lender location may be a runner for the lending institution who travels to banks and credit unions to deposit funds as needed.

In accordance with another aspect of the invention, the mobile lender location may be a deposit courier who deposits funds into the account of the debtor and then obtains reimbursement from the lender. Because the deposit courier does not lend funds to the public and has a service agreement with the lender, the deposit courier is generally not subject to state and federal laws regarding lending institutions.

Ideally, the deposit courier creates bank drafts on the account of the lender to obtain reimbursement of the funds which have been advanced in behalf of the lender. In such a manner, the deposit courier is able to obtain reimbursement of its funds the same business day advanced. A deposit courier may deposit five thousand dollars or more per day in funds for the lenders with which it contracts. If typical billing procedures were followed, the deposit courier would have to have tens of thousands of dollars in liquid cash to cover advanced funds until payment is made. By debiting the account of the lender the same day, the deposit courier can comfortably operate with only two to three times daily deposits in cash.

In accordance with still another aspect of the present invention, the deposit courier can handle payment of both extension requests and the original loan for the lender. Most small post-dated check lenders lack the technology to create checks for repayment of loans which are received via facsimile. Thus, prior to the present invention, the debtor had to create a check and deliver it to the lender. The deposit courier, in contrast, can generate a check for the lender which the lender can then deposit to once the loan is due. If the debtor needs an extension, the deposit courier can create a draft to cover the extension fees and deposit the draft into the lender's account for the lender.

In accordance with yet another aspect of the present invention, the debtor is able to use a payday loan machine at a location remote from the lender. The payday loan machine is configured to allow the debtor to enter needed information, such as name, address, telephone number, employer, compensation and voided check number to the machine. The machine then transmits the information to a central processing location which determines if the individual qualifies for the loan. (This can be done by voice or data lines, wireless or Internet transmission). If the individual qualifies, the machine enables the individual to sign a loan form and the machine distributes the proceeds from the loan. This can be done either by distribution of cash, or by the machine printing a check which will be honored at local merchants, thereby giving the individual ready access to his or her funds.

The payday loan machine can be equipped with data input devices, such as a keyboard, a scanner, a camera or other sensor for verifying the user's identity—i.e. picture, finger print or retinal scan. It also includes a mechanism for generating contracts, either a touch sensitive screen which allows for signatures or a printer for printing contracts, and a mechanism for dispersing loan proceeds.

### BRIEF DESCRIPTION OF THE DRAWINGS

The above and other objects, features and advantages of the invention will become apparent from a consideration of the following detailed description presented in connection with the accompanying drawings in which:

FIG. 1 shows a schematic representation of the method of one aspect the present invention;

FIG. 1A shows a flow chart of the steps associated with the method represented in FIG. 1;

FIG. 1B shows a flow chart of a preferred process of the present invention;

FIG. 2 shows a schematic representation of another aspect of the present invention;

FIG. 2A shows a flow chart of the steps associated with the method represented in FIG. 2;

FIG. 3 shows yet another schematic representation of aspects of the present invention;

FIG. 4 shows still yet another schematic representation of an aspect of the present invention;

FIG. 5 shows yet another schematic representation of an aspect of the present invention;

FIG. 6 shows a perspective view of a payday loan machine made in accordance with the principles of the present invention; and

FIG. 7 shows still another schematic representation of a method for obtaining a loan in accordance with the teachings of the present invention.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

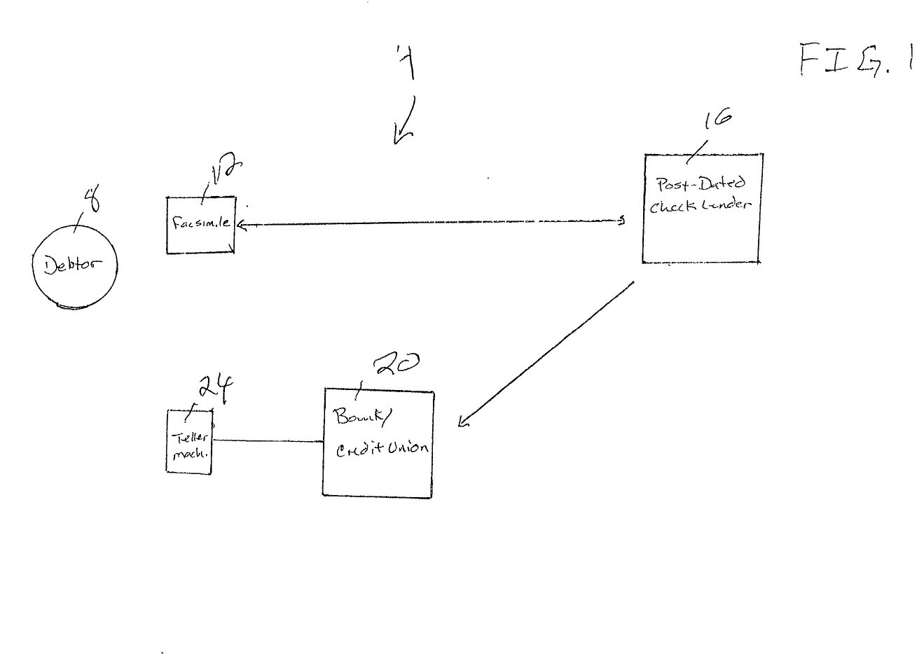

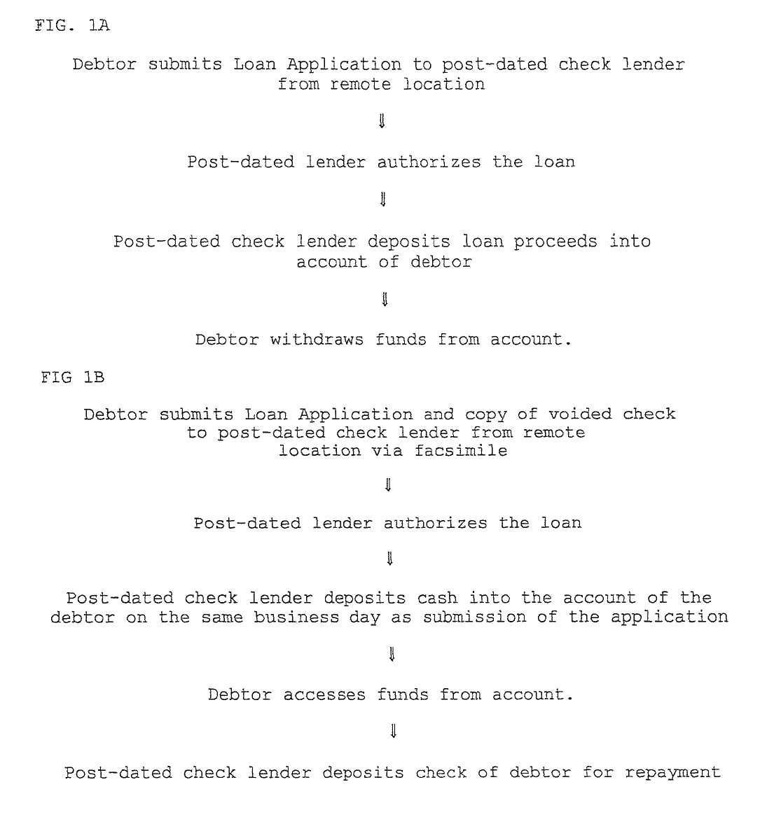

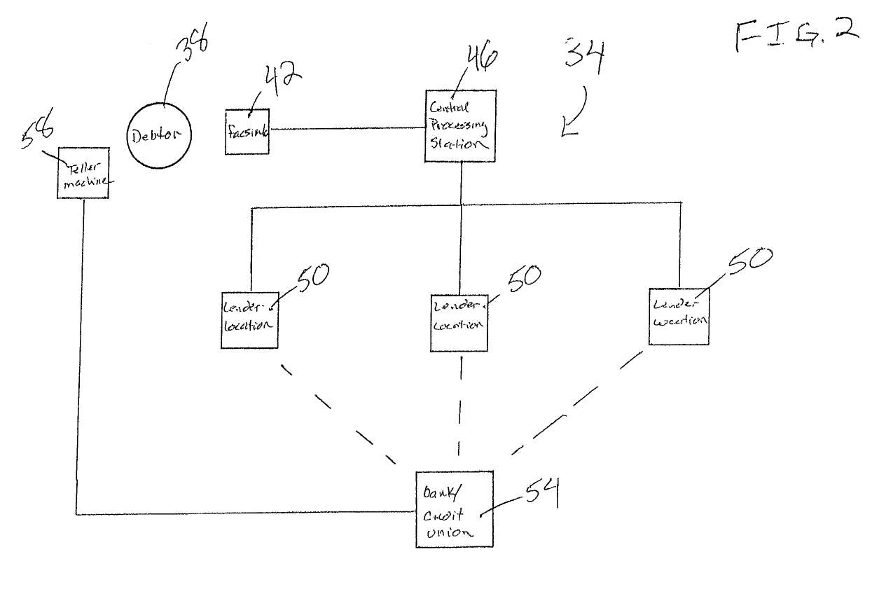

Referring to FIG. 1, there is shown a schematic view representing a method, generally indicated at 4, of processing a loan in accordance with the principles of the present invention. In order to obtain an initial loan, the debtor 8 utilizes a facsimile machine 12 (or telephone or other data transmission means) to transmit a loan application to a post-dated check lender 16. The loan application will typically include a copy of the debtor's most recent pay stub, other relevant information about the debtor such as his or her name, address, and bank or credit union. The debtor 8 will also typically fax a “voided” check as part of the application. As will be explained in additional detail below, the check number from the voided check is utilized by the post-dated check lender to later withdraw funds from the debtor's bank account and thereby pay off the loan.

Because the loan application can be completed by facsimile 12, the debtor 8 is not required to go to the offices of the post-dated check lender 16 to provide the documentation associated with obtaining the loan. The functional equivalent of the post-dated check can be created pursuant the Uniform Commercial Code, Title 1, Section 1-201 (39) and Title 3, Sections 3-104, 3-401 and 3-403, Code of Federal Regulations, Title 12 Chapter II, Part 210 and Regulation J. Federal Reserve Bank, Part 2, Sections 4a-201 to 4a-212. Severe criminal penalties are provided for violating these statutes.

In addition to providing information to the postdated check lender 16 regarding the debtor, information is also provided as to how promptly the debtor 8 needs the money. Thus, for example, if the debtor 8 needs the funds the next business day, the debtor may select one price option which allows the lending institution to wire funds into his or her account at the bank or credit union 20 designated by the debtor.

If, however, the debtor 8 requires funds more promptly than the next business day, the debtor will indicate that the funds are needed on a rush basis. The post-dated check lender 16 will then process the loan within a predetermined amount of time and confirm to the debtor 8 (typically via facsimile) that the funds will be posted in his or her account within the agreed upon time limit. The post-dated check lender 16 then sends a representative to the debtor's bank or credit union 20. The representative of the post-dated check lender 16 deposits funds directly into the debtor's account at the bank or credit union 20. Those of skill in the art will appreciate, in light of the present disclosure, that having funds directly deposited into the individual's account will make those funds more readily available to the debtor 8.

In a preferred scenario, the funds deposited into the debtor's account at the bank or credit union 20 are deposited either in cash or in certified funds. It is common for many banks and credit unions to place holds on funds or checks of individuals, especially those who have questionable credit. However, by depositing cash or certified funds, those funds are immediately available for withdrawal by the debtor (8).

Once the funds have been deposited in the bank or credit union (20) by the representative of the post-dated check lender 16, the debtor 8 may access those funds in a variety of ways. First, the debtor 8 may write a check for any portion of the loan funds. If the recipient of the check performs a merchant verification on the check, the bank or credit union 20 will report that the funds are available for the check to clear and the debtor 8 is able to proceed with the financial transaction.

A more common method of utilizing the loan funds, however, is to directly access the cash which is in the debtor's account at the bank or credit union 20. The debtor 8 may access those funds immediately by visiting the bank or credit union 20, or by using a teller machine 24 at a remote location. The use of the teller machine 24 is particularly advantageous in that it allows the debtor to access the funds even if she or he is in a remote location, such as another state, or even another country. The same procedure can also be used by the debtor 8 to ensure that there are sufficient funds to cover the charges placed on his or her debit card at the supermarket, or to access funds for groceries at the store's teller machine.

The processing of loans as set forth with respect to FIG. 1 has multiple advantages for both the debtor 8 and the post-dated check lender 16. The debtor 8 is able to access loan funds without visiting the physical establishment of a post-dated check lender, which may be in an undesirable part of town, or which may be geographically remote from the debtor. Additionally, the debtor 8 is able to access funds from his or her bank account at the bank in a manner which will not raise any suspicions that the debtor may be having financial difficulties. Finally, the debtor 8 is given the opportunity of using a teller machine at virtually hundreds of thousands of remote locations around the world.

The post-dated check lender 16 obtains the possibility of eliminating his or her physical location. Some post-dated check lenders 16 are located in undesirable parts of town, or in areas without ready access to banks. By utilizing the method of the present invention, the postdated check lender 16 can be conveniently located in a home or in an office building in a central business district with ready access to banks and credit unions. Additionally, by omitting a “store front,” the lender can save a considerable amount of overhead.

More important than the above, however, is that the method of the present invention dramatically increases the effective geographic radius in which the post-dated check lender (16) may operate. While a “store front” for a post-date check lender 16 may serve as a geographic radius of a couple of miles, utilization of the method of the present invention enables the post-dated check lender to effectively serve an entire city and potentially an entire state. (This could be expanded to nationwide once bank deregulation allows for true interstate banking). For example, the loan applications may be sent via facsimile to any location within a city or state, or could be placed at businesses utilizing facsimiles such as copy centers, mail box outlets, and even convenient stores. By faxing the application to a post-dated check lender 16 with an office adjacent a branch near his or her bank, an individual could obtain a loan from virtually any location in the United States, or even abroad. The debtor 8 then need only find a teller machine to have access to the loan proceeds within an hour of originally filing the application.

This is in sharp contrast to the conventional method of handling post-dated loan checks in which the individual must either visit a post-dated check lender 16 in his or her community, or utilize the Internet and be forced to wait until the next business day to obtain the loan proceeds. Because many companies will not accept out of state checks, a person attempting to use a conventional post-dated “store front” while out of town, would be virtually out of luck. Additionally, he or she may not have Internet access and may be unable to wait for one business day to access money. The present invention, in contrast, allows almost immediate access to funds regardless of the location of the individual.

Turning now to FIG. 1A, there is shown a flow chart of the principle steps of the present invention. The first step is for the debtor to send a loan application via facsimile or telephone to a post-dated check lender. The second step is for the post-dated lender to authorize the loan. The third step is for the post-dated check lender to convey funds to the financial institution of the debtor. At that point, the debtor may withdraw the loan proceeds at his or her convenience. This may be done by writing a check, visiting the bank or credit union, or by obtaining cash from a teller machine.

Turning now to FIG. 1B, there is shown a flow chart of the preferred steps of the present invention. The first step is for the user to send a loan application to the post-dated check lender via facsimile. The loan application may be obtained by facsimile or may be acquired from a copy center or other location which provides facsimile services. By having the loan applications at a variety of locations, the postdated lender can effectively expand the geographic area which it can serve. (Those skilled in the art will appreciate that other modifications to the application process, such as use of telephone or Internet could also be used—especially for established customers).

The loan application preferably includes a copy of a “voided” check. The debtor fills out their check register to represent the gross amount which will be deducted from the debtor's account once the post-dated check lender debits the debtor's account in lieu of depositing a post dated check. By entering the amount of the check, the debtor can be assured that he or she will not create an overdraft situation. By receiving the voided check, the post-dated check lender is given all of the information necessary about the debtor's account to debit the account at the appropriate time.

The second step is for the post-dated check lender to approve the loan. This is typically done by ensuring that the debtor is employed and that the debtor's next paycheck will be sufficient to cover the amount being advanced. Thus, the application may require submission of a recent pay stub.

The third step is for the post-dated check lender to deliver loan proceeds to the financial institution of the debtor on the same business day as the loan is submitted to post-dated check lender. Preferably, the deposit is made with cash and the deposit is made within thirty minutes of the loan application being submitted. This enables the debtor to obtain needed funds within a very short period of time.

Upon deposit of the funds in the debtor's account, the debtor may access his or her funds by visiting a bank, by teller machine, or by writing a check. The third-party lender then holds the “check” of the debtor to cover the loan proceeds plus interest and costs, and deposits that check in the lender's bank account to draw from the debtor's account on the agreed upon date.

The steps of the method can be further used by the debtor to purchase extensions on the loan. Thus, for example, if the debtor is unable to meet the loan obligations and other financial requirements upon receipt of his or her next pay check, the debtor may call or facsimile the post-dated check lender and obtain an extension on the loan from the post-dated check lender. This may be accomplished in one of two ways. First, the extension could simply provide that the original check is not cashed by the lender for some additional period of time. In such a scenario, the debtor would also submit information for an additional check to be drawn by the lender to cover the additional interest and costs. Typically, the subsequent check to cover fees is deposited promptly so that the loan amount does not continue to increase.

In the alternative, the lender may deposit the check of the debtor and virtually simultaneously advance the debtor a new amount to cover the check which is being drawn. In such a scenario, the debtor would supply a new check number for payment of the second loan and any additional fees and costs.

The advancing and withdrawal of funds in such a manner, however, is somewhat labor intensive if handled manually. It also raises the risk of other checks clearing before the check to reimburse the original loan.

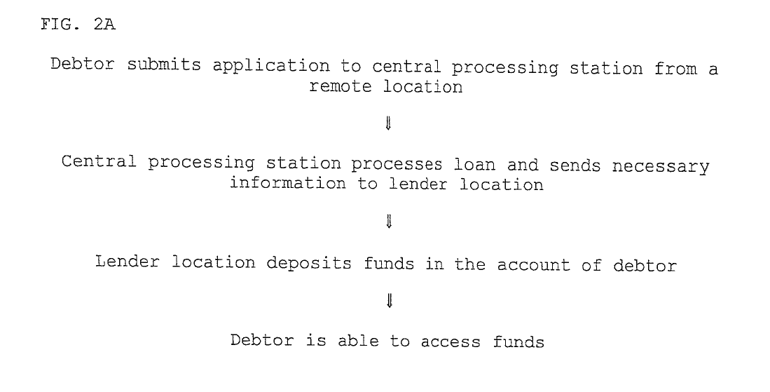

Turning now to FIG. 2, there is shown a schematic representation, generally represented at 34, of an alternate aspect of the present invention. The debtor 38 submits his or her application via a telecommunications medium 42, such as facsimile, telephone or the Internet. The application is submitted to a central processing station 46. The central processing station 46 processes the loans and then relays the information to one of a plurality of lender locations 50. The lender locations 50, in turn, handle the depositing of funds at the bank or credit union 54 of the debtor 38. By having lender locations 50 spread across a geographic region, i.e. a city, a state, or the United States, the central processing station 46 is able to have funds deposited directly into the debtor's account regardless of the location of the debtor or the location of his or her bank. Thus, for example, if the debtor 38 was from Salt Lake City and his bank had only one location, the central processing station 46 could select the lending location 50 which is closest to the debtor's bank and have the lending location make the deposit within the required time limit.

In light of the present disclosure, those skilled in the art will appreciate that the central processing station 46 may serve as the principle lender with each of the lender locations 50 simply serving as runners who deposit cash or certified funds in the debtor's account in the appropriate location. Thus, a single business could have a central processing station 46 and then hire runners in each location served who are paid a fee to deposit money in the debtor's account on behalf of the company. Likewise, the central processing station 46 may be the lender and may rely on a network of independent lenders to advance and deposit funds in the debtor's account. The central processing station 46 may then repay the lender locations, and pay them a premium for advancing the funds.

In the alternative, the central processing station 46 may simply serve as a central clearing house which refers applications to independent post-dated check lenders who serve as the lending locations 50. The independent postdated check lenders serving as the lending locations 50 could simply pay a commission to the company running the central processing station, or the central processing station could be jointly owned by a number of post-dated check lenders who wish to expand their markets.

Those skilled in the art will appreciate that there are advantages and disadvantages to each approach. Regardless of which approach is used, however, the post-date check lender is able to increase his or her market share while minimizing the number of locations needed. No matter which system is used, the debtor 38 is able to access funds via a teller machine 58 or by visiting a branch of his bank or credit union, and is able to have the funds on the same day without visiting the post-dated check lender.

FIG. 2A shows a flow diagram of the fundamental steps of the present invention. The first step is for the debtor to apply for a loan from a remote location. (Those skilled in the art will appreciate that for a repeat customer, this could be accomplished by the customer simply calling to provide check information to the post-dated check lender).

The central processing station processes the loan and relays the necessary information to an appropriate lender location. Typically, the lender location will be either in the home town of the debtor, or at a location which is close to a branch office of the debtor's financial institution. Additionally, either the central processing station or the local lender may serve as the ultimate lender that debits the debtor's bank account when the loan comes due.

The lender location then deposits funds into the debtor's account. Preferably, this is done by depositing cash or certified funds which will not be subject to the possibility that the banks will place the funds of a check on hold for one or more business days to ensure that the check will clear. Once the funds have been deposited into the debtor's account, the debtor is able to access those funds by writing a check, visiting the bank or credit union, or by simply using a teller machine.

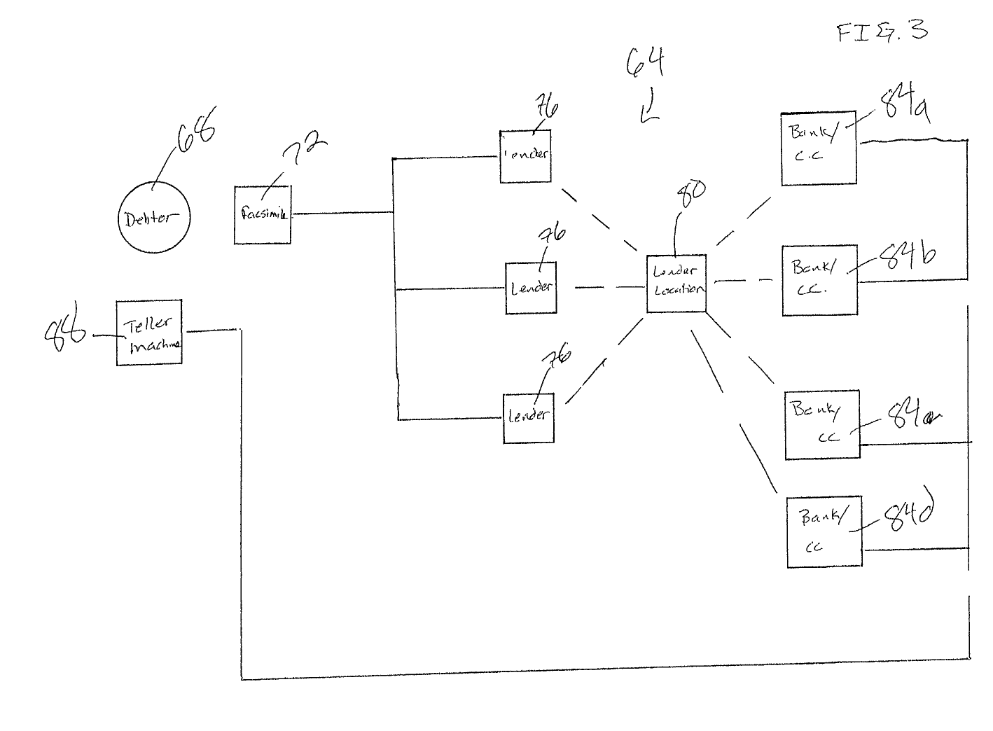

Turning now to FIG. 3, there is shown a schematic view of yet another aspect of the method of the present invention, generally indicated at 64. The debtor 68 utilizes a remote access device such as a facsimile machine 72 to send a loan application to a post-dated check lender 76 based on location or some other factor. The post-dated check lender 76 authorizes the loan and then passes the bank account information to a mobile lending location 80. The mobile lending location 80, in turn, deposits funds into the bank or credit union 84a, 84b, 84c or 84d for the debtor 68. The debtor 68 may then access the funds from a teller machine 88 or any other conventional manner for accessing funds from his or her bank account.

In light of the present disclosure, those skilled in the art will appreciate that the “mobile lending location” need not actually be a “lender” as typically viewed by state and federal lending laws. The mobile lending location may simply be a runner employed by the lender, or may be an independent deposit courier that deposits cash on behalf of the lender and is then reimbursed.

The mobile lender location 80 in the form of a deposit courier is advantageous because it eliminates the need for every post dated check lender 76 to have its own employees who will travel to each bank in which a deposit needs to be made. Thus, while the lender location may be in commercial development, i.e. near grocery stores and the like, the mobile lending location can be in the financial district of town where it has ready access to most banks and credit unions. Additionally, by having numerous post-dated check lenders 76 using a common mobile lending location 80, an economy of scale is reached which makes the one-hour deposit service more profitable.

At the end of each day, the mobile lending location 80 may submits a bill to each post dated check lender 76 and is paid the amount deposited for that lender's clients, plus it's fee for performing the deposit. The post-dated check lender 76 then carries the loan until the debtor's “check” is cashed on the agreed upon date.

A preferred method of repayment for the deposit courier serving as a mobile lending location 80 is to create a bank draft on the lender's account. Once the lender has approved the funds advanced for its clients, the deposit courier may deposit the bank draft in its account and thereby transfer funds from the lender on the same day they were advanced.

The deposit courier serving as the mobile location lender 80 may advance five to ten thousand dollars per day for the client's of the lenders for which it works. If the lender takes even a week to pay, the deposit courier would need to have approximately $70,000 available to cover deposits. In contrast, by submitting a bank draft on the lender's account each day, the deposit courier can comfortably operate with only $15,000 in available cash.

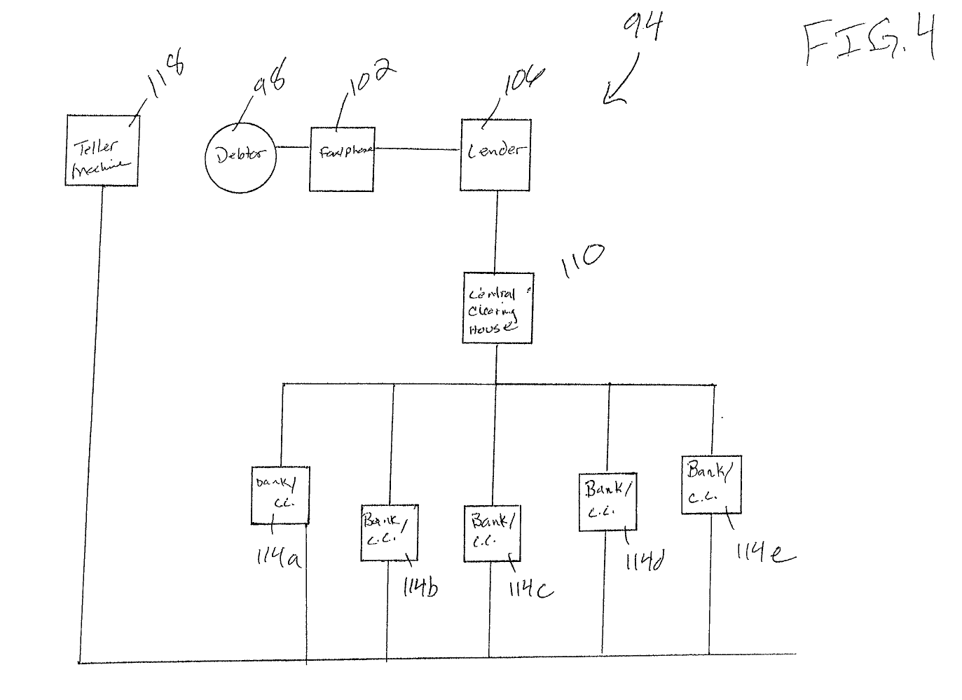

Turning now to FIG. 4, there is shown yet another application of the method of the present invention, generally indicated at 94. The debtor 98 submits the application by facsimile 102 to the post-dated check lender 106. The post-dated check lender 106 then processes the loan to determine whether it should be approved. Upon approval, the post-dated check lender 106 has an employee or other representative take cash or certified funds to a central service center 110 which is tied into to a plurality of banks or credit unions 114a-114e. Central service center 110 are not uncommon for small credit unions and the like to give them a greater economy of scale.

In the present invention they are particularly useful because the central service center 110 will usually accept deposits for any of its members and post them immediately to the appropriate account. Thus, by making one stop at the central service center 110, the post-dated check lender 106 is able to make deposits into multiple banks or credit unions at the same time. By locating its operations adjacent to a central service center 110, the post-dated check lender 106 is able to provide 30 minute or one hour service for customers of numerous financial institutions by having an employee simply walk to the service center 110 and make the deposit. Because there is no need for runners, cars and travel time, very prompt service can be provided at a very small premium over the conventional post-dated check systems. In light of the above-disclosure, those skilled in the art will appreciate that a “post-dated check” refers to any situation in which a short-term loan is provided and the debtor's account will be debited or otherwise charged for the loan on an agreed upon date.

While the procedures set forth above are typical for original loans, those skilled in the art will appreciate that repeat customers could obtain loans within an hour simply by providing check information and confirming their identity. This could be provided in a variety of manners, such as use of a touch tone telephone with an automated call reception system, or use of the Internet.

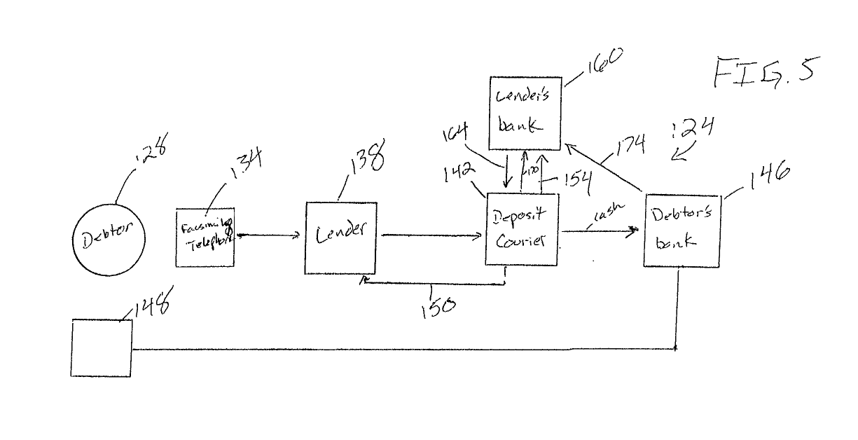

Turning now to FIG. 5, there is shown a schematic representation of another aspect of the present invention, generally indicated at 124. The debtor 128 submits a request for a loan from a remote location 132 as indicated above. The lender 134 processes the loan to ensure that the debtor is eligible. Typically this will include a check of whether the debtor has other post-dated check loans pending, whether the debtor is employed and whether he is in bankruptcy proceedings.

If the debtor 128 qualifies, the lender gives the account and fund information to the mobile lender location 142 who, in the present example, is an independent deposit courier. The independent deposit courier 142 visits the debtor's bank, credit union or a central service station 146 and deposits the necessary funds which may be accessed from teller 148. The deposit courier 142 then generates a form to the lender 138 for confirmation that the funds have been deposited. The deposit courier 142 also generates a draft (represented by arrow 150) to obtain repayment of the loan. The draft 150 is sent to the lender 138 for deposit against the debtor's account on the agreed date.

Because the lender 138 typically will not have the technology to create bank drafts, the deposit courier 142 provides the ability for the lender 138 to obtain repayment of the loan. With such a repayment method, the lender 138 would be forced to obtain a check from the debtor 128. Obtaining a check from the debtor, however, raises the problems discussed in the background section and renders remote application/receipt of funds functionally impossible.

In addition to creating a draft on the debtor's account, the deposit courier also creates a draft on the lender's account. The draft, represented by arrow 154, is submitted to lender's bank 160 and provides same day repayment, represented by arrow 164, to the deposit courier 142. (Typically, the deposit courier 142 will create a single draft to cover all cash advances for a particular lender on that day.) This enables the deposit courier 142 to operate with a relatively small amount of cash on hand, while allowing even small lenders to offer the service of remote loan application/access to funds.

In the event that a debtor 128 needs an extension to repay the loan, lender 138 forwards the appropriate information to the deposit courier 142. The deposit courier 142 can then generate a bank draft, represented by arrow 170 and deposit it in the lender's bank 160. The bank draft 170 causes the debtor's bank to forward fund to the lender's account, represented by arrow 174, to cover the extension fee and any charges of the deposit courier 142. In such a manner, the debtor 128 is able to obtain a post dated check loan and extensions without ever having to visit the physical location of the lender 138. Additionally, the lender 138 can offer such services without having to hire runners, and without having to develop technology to generate and process bank drafts.

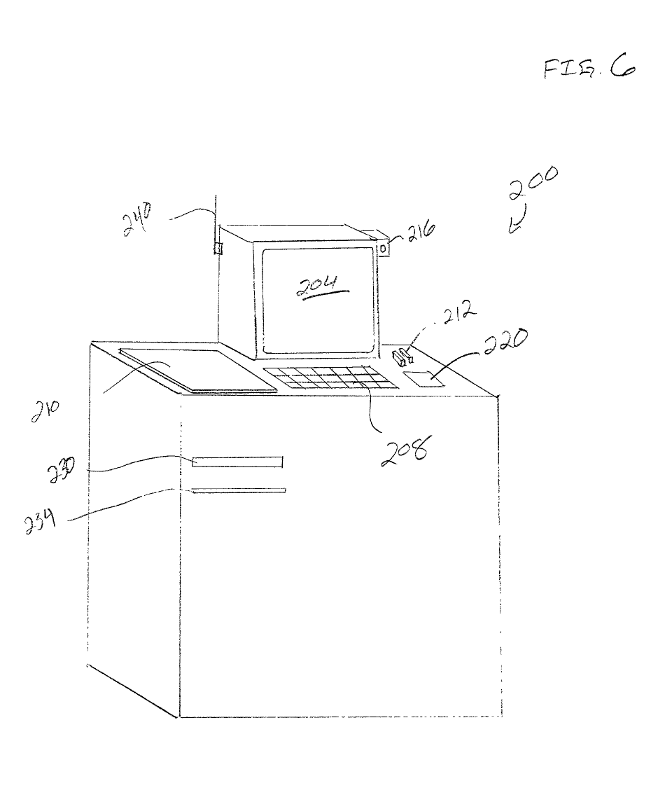

Turning now to FIG. 6, there is shown a payday loan machine, generally indicated at 200, made in accordance with an alternate embodiment of the present invention. In order to enable a user to complete a loan transaction at a remote location, the payday loan machine includes a device or devices for inputting information about the debtor. For example, as shown in FIG. 6, the payday loan machine 200 includes a monitor 204 which relays information to the debtor and can be used to input information about the debtor (such as a monitor provided with a touch screen surface). Typically associated with the monitor 204 is a keyboard 208 or keypad which can be used to input information about the debtor. Furthermore, a scanner 210 can be used to take copies of the debtor's driver's license, pay stub, and a voided check.

Also shown in FIG. 6 is a card reader 212, the card reader can be used to read information about the debtor from the magnetized strip on many driver's licenses. Additionally the card reader could be used to read information about the debtor's bank account from his or her debit card.

Other ways of verifying the identity of the debtor include a camera 216 which can either take a picture of the debtor or take a retinal scan. A screen 220 capable of taking a finger or hand print could also be used.

The payday loan machine 200 will also often include a printer 230 for printing copies of loan agreements. The printer 230 can also be used to print a check made out to the debtor or a neighboring business, which can be used or cashed by the debtor. Furthermore, the payday loan machine 200 can also include a cash dispenser 234 which will dispense the proceeds of the loan in cash. Those familiar with the industry, however, will appreciate that machines which dispense cash are a higher security risk, as thieves will often attempt to break into the machine.

In use, the debtor approaches the payday loan machine 200 and uses the screen of the monitor 204 or the keyboard 208 to select from available programs. For example, if the debtor is a repeat customer, he or she will not need to provide all of the information needed from a new customer. Additionally, the customer can be given the option of selecting a loan wherein the proceeds are dispensed from the machine, or a loan in which the proceeds are deposited into the customer's bank account. If the customer has a card with a magnetized strip, the card reader 212 can also be used to partially fill out an application form, etc.

Once the customer has selected the type and amount of loan desired, the lender should obtain certain information regarding the customer. In particular, the lender should verify the identity of the customer; verify that the amount on the customer's most recent pay stub is sufficient to cover the loan; and verify the account number against which the lender will create a draft or other repayment at the end of the loan term. This is may be accomplished by having the customer scan their driver's license, most recent pay stub and a voided check on the scanner 210. If the customer has a magnetized driver's license and/or debit card, however, much of this information can be obtained by the card reader 212.

The lender can then verify that the customer is able to repay the loan and ensure that the customer does not have prior loans already out against the next paycheck. This will typically be done by a transmitter 240 or telephone line relaying the information to a central processing center which manually verifies the information. In time, however, it is likely that verification of all the relevant information will be able to be done electronically.

Once the customer's information has been verified and the customer approved for the loan, loan documents are generated for execution by the customer. The loan documents can be printed by the printer 230, or a digital copy of the loan document can be produced on a screen which can receive the customer's signature. Even if the contract is executed digitally, however, the customer will usually be given a copy of the contract.

To further verify the identity of the customer, a photograph, retinal scan or finger or hand print can be taken via the camera 216 or the pad 220. An advanced scanner 210 could also be used for this purpose. The verification information can then used by the company operating the payday loan machine 200 to confirm the identity of the debtor and can be used subsequently for identification purposes. Additionally, the information can be shared with other payday loan machine operators to ensure that the debtor is a good risk.

After execution of the loan agreement, the proceeds of the loan may be given to the customer, or deposited into his or her bank account—depending on the desires of the customer. If dispensed to the customer, the proceeds could be in the form of cash, or in the form of a check which could be cashed at nearby businesses.

One common scenario in which the payday loan machine 200 would be particularly beneficial is on vacation. If the customer runs out of money, he can use the payday loan machine 200 to obtain a check to cover his expenses. This is particularly valuable because most businesses will not accept out of town checks. Thus, even if the customer has money in his checking account, he may be unable to access the money unless he is near a debit machine which operates on the same system as his home bank. If a debit machine is not readily available or if the debit card has been lost or stolen, the customer may have no access to his or her funds.

Another common scenario is a vacation in which the customer has simply overspent and lacks sufficient money in his bank account to return home. The payday loan machine 200 allows the customer to obtain needed funds regardless of whether he has sufficient funds or whether those funds are readily accessible.

Still another scenario in which the payday loan machine 200 is advantageous is if the customer realizes that he has overdrawn his bank account or will have automatic withdrawals which exceed his available funds. By using a payday loan machine at virtually any location, the customer can have funds deposited into his bank account to cover the short fall and avoid having checks be dishonored.

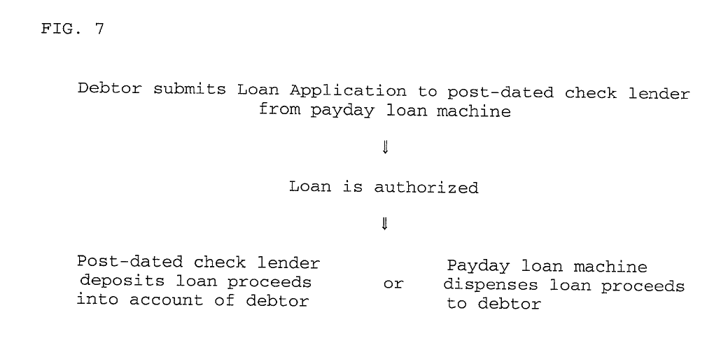

Turning now to FIG. 7, there is shown a schematic representation of the use of a payday loan machine, such as machine 200 in FIG. 6, to obtain loan funds. The customer uses the payday loan machine to enter information about himself, his payment and banking information and the needed loan. The post-dated check lender then approves or denies the loan. If the loan is approved, the loan proceeds can be dispensed directly into the account of the customer, or can be dispenses directly to the customer in cash or via a check, cashier's check or traveler's check.

Thus there is disclosed an improved method for processing a loan. Those skilled in the art will appreciate numerous modifications which can be made without departing from the scope and spirit of the present invention. The appended claims are intended to cover such modifications.

What is claimed is:

1. A method for processing loans comprising:
(a) receiving a loan application at a post-dated check lender from a debtor at a remote location;
(b) processing the loan application;
(c) dispensing the loan proceeds to the debtor in response to the loan.

2. The method for processing loans according to claim 1, wherein the method comprises receiving the loan application via a facsimile or scanner.

3. The method for processing loans according to claim 1, wherein the method comprises distributing the loan proceeds to the debtor in the form a check printed at the remote location.

4. The method for processing loans according to claim 1, wherein the method comprises obtaining digital information from the debtor's debit card.

5. The method for processing loans according to claim 1, wherein the method comprises receiving a copy of a check of the debtor via facsimile or scanner.

6. The method for processing loans according to claim 1, wherein the method comprises depositing funds into the account of the debtor so that they post to the debtor's account on the same date as the loan application.

7. The method for processing loans according to claim 1, wherein the method comprises dispensing funds directly to the debtor.

8. The method for processing loans according to claim 7, wherein the method comprises dispensing cash to the debtor.

9. The method for processing loans according to claim 8, wherein the method comprises dispensing a check to the debtor.

10. The method for processing loans according to claim 1, wherein the method comprises receiving the loan application at a central processing station and verifying information on the loan.

11. The method for processing loans according to claim 10, wherein the central processing station debits the debtor's account to repay the loan.

12. The method for processing loans according to claim 1, wherein the method comprises verifying the identity of the debtor.

13. The method for processing loans according to claim 12, wherein the identity of the debtor is verified by one of taking a photograph of the debtor, taking a retinal scan of the debtor or taking a finger print of the debtor.

14. A method of making funds available for immediate access from a lending institution to a loan applicant, comprising;
providing a loan application to a debtor at a payday loan machine;
receiving a transmission containing a completed loan application;
processing the completed loan application for approval of a loan; and
delivering funds upon approval of the loan application to the debtor at the payday loan machine.

15. The method of claim 14, wherein the payday loan machine comprises a facsimile machine.

16. The method of claim 14, wherein the payday loan machine is located in one of the group consisting of a copy center, a mail receiving center, a mall, a grocery store and a convenience store.

17. The method of claim 14, further including providing confirmation or denial of the loan application via the payday loan machine.

18. The method of claim 14, further including withdrawing an amount from the applicant's bank account equal to the loan amount plus a loan fee on a date agreed upon by the lending institution and the applicant.

19. The method of claim 14, further receiving a request from the loan applicant for an extension of the repayment date via the payday loan machine, extending the date and charging the loan applicant an additional loan fee for the extension.

20. An apparatus for applying for loans and dispensing loan proceeds, the apparatus comprising:
means for transmitting information regarding a debtor to a central location;
means for supplying a loan contract to the debtor and for conveying execution of the contract to the central location; and
means for dispensing funds to the debtor.

21. The apparatus of claim 20, wherein the means for transmitting information regarding the debtor comprises at least one of the group consisting of a scanner, a facsimile, a card reader, a keyboard and a camera.

22. The apparatus of claim 21, wherein the means for supplying a loan contract comprises at least one of the group consisting of a printer and a touch sensitive screen.

23. The apparatus of claim 22, wherein the means for dispensing funds comprises at least one of the group comprising a printer configured for printing checks and a cash dispenser.
